(19) United States
(12) Patent Application Publication
(10) Pub. No.: US 2025/0354354 A1
(43) Pub. Date: Nov. 20, 2025

(54) SAFETY SYSTEM FOR MACHINERY

(71) Applicant: SPEC. Control Systems Ltd., Sorrento (CA)

(72) Inventors: Shawn Colin BRYCE, Sorrento (CA); Lisa Darlene SORENSEN-BRYCE, Sorrento (CA)

(73) Assignee: SPEC. Control Systems Ltd., Sorrento (CA)

(21) Appl. No.: 19/211,812

(22) Filed: May 19, 2025

Related U.S. Application Data
(60) Provisional application No. 63/649,087, filed on May 17, 2024.

(51) Int. Cl. E02F 9/24; E02F 9/26; G06N 20/00

(52) U.S. Cl. CPC E02F 9/24; E02F 9/262; G06N 20/00

(57) ABSTRACT

A safety system for a machine and a method of safely operating a machine are disclosed. A controller is connected to image sensors and a plurality of detectors. These are positioned to, around the machine, respectively, image a predetermined work zone and detect personnel, without imaging, in a plurality of non-overlapping operator zones. The controller uses a machine learning model to detect personnel in the imaged scenes based on data received from the image sensors and indicative of imaged scenes of the work zone. The controller operates a safety indicator to indicate (a) unsafe operation in response to detecting personnel in the work zone or in at least two of the plurality of operator zones, and (b) safe operation in response to detecting personnel in only one of the plurality of operator zones while detecting no personnel in the work zone.

### CROSS-REFERENCE TO RELATED APPLICATIONS

Any and all priority claims identified in the Application Data Sheet, or any correction thereto, are hereby incorporated by reference under 37 CFR 1.57.

This application claims the benefit of U.S. Provisional Application No. 63/649,087 filed on 17 May 2024.

Each of the aforementioned applications is incorporated by reference herein in its entirety, and each is hereby expressly made a part of this specification.

### TECHNICAL FIELD

The technical improvements herein relate generally to workplace and equipment safety, and more particularly to safety systems for machinery.

### BACKGROUND

Operation of industrial and heavy machinery requires adherence to strict safety regulations and protocols due to the high risk of injury, to both operators and bystanders, and material damage. A common protocol in case of a safety breach is to render the equipment inoperable, that is to shutdown any moving parts or mobile components of the equipment, such as a booms, arms, or wheels, or in some cases a complete shutdown of the equipment. While shutdowns and other preventative or curative actions are important, as safety failures can have disastrous consequences, they are difficult and expensive to implement. For example, dedicated trained and authorized safety professionals are often required on-site or otherwise employed, detailed paperwork relating to risks and safety plans may need to be prepared and approved beforehand, and shutdowns themselves may hamper productivity and efficiency, leading to high costs.

In underground mining and tunnelling operations heavy and industrial equipment is often operated remotely by a remote operator located at a distance from the equipment, typically using handheld remote controls. In any remote equipment operation visibility is an issue, it can often be difficult to see movement of the equipment or to confirm if anyone is in the vicinity of the moving parts. It is important to prevent individuals from entering unsafe areas and operation of machinery where risks to life and limb are unacceptably high.

Present safety systems typically rely upon one of three solutions. A first solution involves placing physical barricades around machinery to stop remote operator(s) or other personnel entering into an unsafe area. Physical barricades need to be made very high, heavy, and large in order to mitigate individuals scaling, removing, or otherwise bypassing the physical barricades to enter unsafe areas. A second solution involves forming infrared (IR) or laser security curtains around the unsafe area.

A remote operator or personnel crossing a curtain threshold into the unsafe area breaks the curtain, which may then initiate an appropriate safety protocol, a set of predefined steps operators are required to take in the event of a break in the curtain. Once an individual has already crossed the curtain, their movements may not be detected by the curtain anymore as there is no longer a break. For example, if two individuals break the curtain simultaneously and one of them is removed, the second may remain in an unsafe area without an operator necessarily having knowledge thereof, since no further curtains need to be crossed in order to remain in the unsafe area.

A third solution involves radio-frequency identification (RFID) tags worn on a jacket or hard hat of remote operators or personnel to detect entry into an unsafe area, which may then trigger a safety protocol. It is possible for an operator to mistakenly or purposefully leave such an RFID tab behind in a safe zone and travel into an unsafe zone without it. Providing every operator with sufficient RFID tags and the RFID sensing and tracking equipment may costly and may not prevent non-registered users from entering unsafe areas.

It is also often difficult to adjust safety systems to different conditions such as higher traffic areas with multiple equipment and people or for equipment with different primary operations and having multiple unsafe zones, associated with multiple moving parts.

Improvement is desired.

### SUMMARY

It is found that advantages may be achieved by implementing a safety system that not only monitors zones that are considered unsafe, but also monitors zones that are considered to be safe as well as tracks operator-specific zones in order to ensure that zones without an operator are designated unsafe when an operator in a safe zone is detected. Particular advantages, e.g. high fidelity, accuracy, redundancy, cost effectiveness, computational efficiency, and low latency, may be achieved when monitoring of these two zones are carried out by separate types of devices.

There is described a safety system for a machine. The safety system also includes one or more image sensors positioned to image a predetermined work zone around the machine; a plurality of detectors defining a predetermined plurality of operator zones of the machine that are non-overlapping, the plurality of detectors being suitable to detect personnel in the plurality of operator zones without imaging the plurality of operator zones, the plurality of operator zones at least partially non-overlapping the work zone; and a controller communicatively coupled to the one or more image sensors and the plurality of detectors, the controller configured to receive data from the one or more image sensors indicative of imaged scenes of the work zone, use a machine learning model to detect personnel in the imaged scenes based on the data, cause a safety indicator to indicate unsafe operation of the machine in response to the machine learning model detecting personnel in the work zone, cause the safety indicator to indicate safe operation of the machine in response to the plurality of detectors detecting personnel in a non-predetermined first operator zone of the plurality of operator zones while detecting no personnel in the plurality of operator zones other than the first operator zone and while the machine learning model detects no personnel in the work zone, and cause the safety indicator to indicate unsafe operation of the machine in response to the plurality of detectors detecting personnel in a non-predetermined second operator zone of the plurality of operator zones while detecting personnel in the first operator zone, the second operator zone being separate from the first operator zone. Other embodiments of this aspect include corresponding computer systems, apparatus, and computer programs recorded on one or more computer storage devices, each configured to perform the actions of the methods.

Implementations may include one or more of the following features. The safety system where the safety indicator includes an audible alarm configured to generate sound to indicate unsafe operation of the machine. The safety indicator includes a lighting assembly configured to generate light to indicate unsafe operation of the machine. The safety indicator is configured to generate a plurality of zone-specific indicators to indicate at least one of presence of personnel or no presence of personnel in the work zone and the plurality of operator zones. The safety indicator is operably coupled to the machine and is configured to indicate unsafe operation of the machine by causing stoppage of the machine when the controller detects no personnel in the work zone and the controller detects no personnel in the plurality of operator zones. The plurality of detectors includes a plurality of motion sensors. The machine learning model is an object detection model suitable to recognize objects in the imaged scenes based on the data. Each detector of the plurality of detectors defines an exclusive one of the plurality of operator zones. The safety indicator is operably coupled to the machine and is configured to indicate unsafe operation of the machine by causing stoppage of the machine. The safety indicator is controllably connected to a power source of the machine and is configured to indicate unsafe operation of the machine by controlling power supplied from the power source to the machine to prevent operation of the machine. The plurality of detectors includes a plurality of passive infrared sensors. The one or more image sensors are optical image sensors. In various implementations, the features above may be combined in whole or in part. Implementations of the described techniques may include hardware, a method or process, or computer software on a computer-accessible medium.

There is described a monitored machine system. The monitored machine system comprises machinery and the safety system, wherein the machinery includes the machine. In various implementations, the one or more image sensors are mounted on the machinery, and/or the plurality of detectors is mounted on the machinery.

There is described a method of safely operating a machine. The method also includes receiving data indicative of imaged scenes of a predetermined work zone defined around the machine; using a machine learning model to detect personnel in the imaged scenes based on the data; causing a safety indicator to indicate unsafe operation of the machine in response to the machine learning model detecting personnel in the work zone; receiving a first signal, from a plurality of non-image detectors defining a plurality of operator zones of the machine, indicative of detection of personnel in a non-predetermined first operator zone of the plurality of operator zones; causing the safety indicator to indicate safe operation of the machine in response to detecting personnel in the first operator zone while detecting no personnel in the plurality of operator zones other than the first operator zone and while the machine learning model detects no personnel in the work zone; receiving a second signal, from the plurality of non-image detectors, indicative of detection of personnel in a non-predetermined second operator zone of the plurality of operator zones, the second operator zone being separate from the first operator zone; and causing the safety indicator to indicate unsafe operation of the machine in response to detecting personnel in the second operator zone while detecting personnel in the first operator zone. Other embodiments of this aspect include corresponding computer systems, apparatus, and computer programs recorded on one or more computer storage devices, each configured to perform the actions of the methods.

Implementations may include one or more of the following features. The method where the safety indicator, to indicate unsafe operation, causes stoppage of the machine by preventing supply of power to the machine, and the safety indicator, to indicate safe operation, causes supply of power to the machine. The plurality of detectors includes a plurality of passive infrared sensors. The method may include receiving a third signal, from the plurality of non-image detectors, indicative of detection of no personnel in the plurality of operator zones; and causing stoppage of the machine in response to the third signal. In various implementations, the features above may be combined in whole or in part. Implementations of the described techniques may include hardware, a method or process, or computer software on a computer-accessible medium.

There is described a method of safely operating a machine. The method also includes receiving data indicative of imaged scenes of a predetermined work zone defined around the machine; using a machine learning model to detect personnel in the imaged scenes based on the data; causing stoppage of the machine in response to the machine learning model detecting personnel in the work zone; receiving a first signal, from a plurality of non-image detectors defining a plurality of operator zones of the machine, indicative of detection of personnel in a non-predetermined first operator zone of the plurality of operator zones; energizing the machine to prevent stoppage of the machine in response to detecting personnel in the first operator zone while detecting no personnel in the plurality of operator zones other than the first operator zone and while the machine learning model detects no personnel in the work zone; receiving a second signal, from the plurality of non-image detectors, indicative of detection of personnel in a non-predetermined second operator zone of the plurality of operator zones, the second operator zone being separate from the first operator zone; and causing stoppage of the machine in response to detecting personnel in the second operator zone while detecting personnel in the first operator zone. In various implementations, the features above may be combined in whole or in part. Other embodiments of this aspect include corresponding computer systems, apparatus, and computer programs recorded on one or more computer storage devices, each configured to perform the actions of the methods.

There is described a non-transitory computer-readable medium having stored thereon machine interpretable instructions which, when executed by a processor, cause the processor to execute one or more methods and their implementations described herein.

There is described a system comprising: a processor; computer-readable memory coupled to the processor and storing processor-executable instructions that, when executed, configure the processor to execute one or more methods and their implementations described herein.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a schematic diagram of a safety system, in accordance with an embodiment;

FIG. 2 is a schematic diagram of components of the safety system, in accordance with an embodiment;

FIG. 3 is a circuit diagram of the system, in accordance with an embodiment;

FIG. 4 is a flow chart of an example method of safely operating a machine;

FIGS. 5A-5E illustrate various stages of operation of a monitored machine system, in accordance with an embodiment;

FIG. 5A illustrate a first stage of operation of a monitored machine system, in accordance with an embodiment;

FIG. 5B illustrate a second stage of operation of a monitored machine system, in accordance with an embodiment;

FIG. 5C illustrate a third stage of operation of a monitored machine system, in accordance with an embodiment;

FIG. 5D illustrate a fourth stage of operation of a monitored machine system, in accordance with an embodiment;

FIG. 5E illustrate a fifth stage of operation of a monitored machine system, in accordance with an embodiment;

FIG. 6 is a flow chart of another example method of safely operating a machine; and

FIG. 7 illustrates a block diagram of a computing device, in accordance with an embodiment of the present application.

### DETAILED DESCRIPTION

The following description relates to a safety system for a machine. In some embodiments, the systems and methods disclosed herein can facilitate low-cost, flexible, real-time, intervention-free monitoring of areas around machinery.

The description that follows and the embodiments described therein are provided by way of illustration of an example, or examples, of particular embodiments of the principles of various aspects of the present description. These examples are provided for the purposes of explanation, and not of limitation, of those principles and of the description in its various aspects.

The present description teaches an adaptable safety system and method for heavy machinery or equipment operation that includes multiple interconnected safety modules which work together to define safe and unsafe zones for humans, animals, or vehicles—herein collectively referred to as “personnel”—relative to proximity of the equipment, wherein the system and method can render the equipment inoperable if a safety threshold is breached.

The safety modules of the present system work together to provide a two-tier safety system that has both reactive critical shutdown systems and passive proactive monitoring, which ideally shut down the system faster in potentially unsafe situations than with just one of the systems alone.

A safety system for a machine and a method of safely operating a machine are disclosed. A controller is connected to image sensors and a plurality of detectors. These are positioned to, in and/or around the machine, respectively, image a predetermined work zone and detect personnel, without imaging, in a plurality of non-overlapping operator zones. The controller uses a machine learning model to detect personnel in the imaged scenes based on data received from the image sensors and indicative of imaged scenes of the work zone (the controller is configured to process the data using the machine learning model). The controller operates a safety indicator to indicate (a) unsafe operation in response to detecting personnel in the work zone or in at least two of the plurality of operator zones, and (b) safe operation in response to detecting personnel in only one of the plurality of operator zones while detecting no personnel in the work zone.

A system is provided for monitoring presence of personnel within a vicinity of equipment with moving parts. The system comprises a first safety module comprising one or more cameras positioned in relation to the equipment, each of said one or more cameras having a field of view that each define an unsafe zone in which personnel should not be present, wherein the cameras are configured to transmit camera data in real time; a second safety module comprising one or more passive infrared (PIR) detectors, each of said one or more PIR detectors defining a safe zone in which personnel should reside, wherein the PIR detectors are configured to transmit PIR detector data in real time; a control unit configured to receive in real time camera data and PIR detector data, said processor comprising algorithms to interpret camera data to determine presence of personnel in any one of the one or more unsafe zones, and to interpret PIR detector data to determine absence of personnel from any one of the one ore more safe zones; and operable with the equipment to automatically shutdown one or both of a) the moving parts of the equipment and b) the equipment entirely in the case of either presence of personnel in any one of the one or more unsafe zones or absence of personnel from any one of the one ore more safe zones; and a processor located in the proximity of the equipment and configured in relation with the equipment to receive data from the processor regarding presence of personnel in each of the unsafe zones and display that data for viewing.

A method is also provided for monitoring presence of personnel within a vicinity of equipment with moving parts. The method comprises the steps of: monitoring one or more unsafe zones in a vicinity of the moving parts, in which personnel should not be present; monitoring one or more safe zones in relation to the equipment in which personnel should reside; transmitting in real time monitoring data about the one or more unsafe zones and the one or more safe zones to a control unit; interpreting by the control unit presence of personnel in any one of the one or more unsafe zones and absence of personnel from any one of the one ore more safe zones; controlling by the control unit automatic shutdown of one or both of a) the moving parts of the equipment and b) the equipment entirely in the case of either presence of personnel in any one of the one or more unsafe zones or absence of personnel from any one of the one or more safe zones

It is to be understood that other aspects of devices, systems, and methods will become readily apparent to those skilled in the art from the following detailed description, wherein various embodiments are shown and described by way of illustration. As will be realized, the devices, systems, and methods disclosed herein are capable of other and different embodiments and its several details are capable of modification in various other respects, all without departing the scope. Accordingly, the drawings and detailed description are to be regarded as illustrative in nature and not as restrictive.

Several advantageous may accrue. For example, in various embodiments, the system may be implemented for all types of persons, including existing workers and strangers entering into the work zone for the first time, since it requires no variables. For example, operators and other personnel may not require wearing wearable to ensure their protection and may not need to be reminded to adopt safety precautions. For example, costs may be lower for these reasons, which may increase overall take up of safety systems. For example, the system may require no fixed infrastructure and may be operated using machine power without an external power source. For example, the monitored zones may not generally be limited to linear zones. For example, operational redundancy is achieved.

Aspects of various embodiments are described in relation to the drawings in the figures. The drawings are not necessarily to scale and in some instances, proportions of elements in the drawings are chosen to allow for clearer depiction of features.

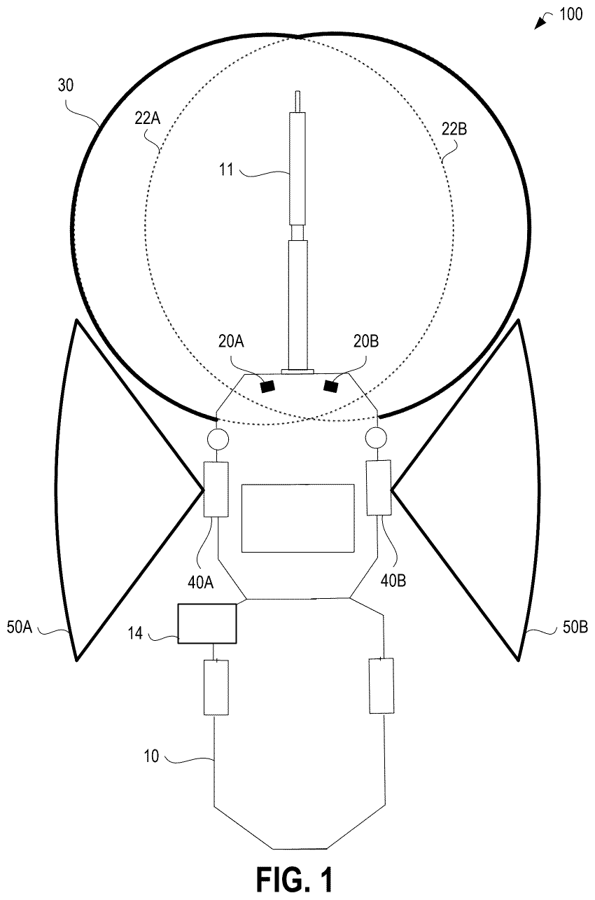

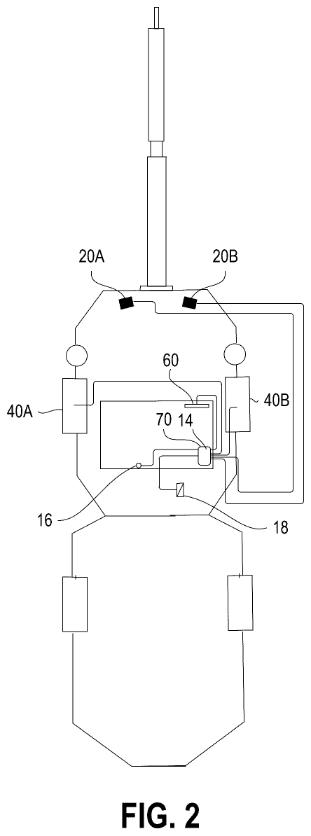

Referring to FIGS. 1-2, the present system 100 may be used in conjunction with any equipment or machine 10 having moving parts, e.g. a boom 11. The system 100 includes a first safety module that provides the reactive critical shutdown of the machine 10 and moving parts, e.g. a boom 11. The first module may take the form of one or more image sensors 20A, 20B positioned to image a predetermined work zone 30 around the machine 10. The work zone 30 is predetermined as it is defined by the region in which the one or more image sensors perform sensing, which is predetermined. As such, as referred to herein, the work zone 30 is defined by the field(s) of view (or range) and the position of the one or more image sensors 20A, 20B. For example, the one or more image sensors 20A, 20B may be positioned on the machine 10. In various embodiments, the one or more image sensors 20A, 20B may form part of one or more integrated cameras. The image sensors 20A, 20B may in general generate a two-dimensional array of sensed data based on sensed electromagnetic radiation in one or more predefined spectral bands. In some embodiments, the image sensors 20A, 20B may be optical image sensors. In some embodiments, the image sensors 20A, 20B may be infrared image sensors.

In various embodiments, the image sensors 20A, 20B may be part of machine learning-enabled cameras suitable for object detection.

In the passages that follow, reference to image sensors 20A, 20B in the plural is made for the reader's convenience and is not to be understood to preclude the first module comprising no more than a single image sensor. In FIG. 1, two image sensors 20A, 20B are shown, although it would be well understood by anyone of skill in the art that any number of image sensors 20A, 20B (and/or cameras) can be used and positioned at various locations along or on the equipment.

The system 100 is configured to use a machine learning model to detect personnel in fields of view 22A, 22B of the image sensors 20A, 20B based on data indicative of imaged scenes generated by the image sensors 20A, 20B. It is understood that the field of view 22A, 22B of an image sensor may refer to fields of views achieved by lenses and/or other optical elements operating in conjunction with the image sensors 20A, 20B. For example, such lenses may form part of cameras.

The fields of view 22A, 22B of each image sensor 20A, 20B preferably overlap to define a contiguous work zone 30 where the machine 10 is to be operated in or on. Such a work zone 30 may be unconsidered unsafe since it can be expected to lead to increased hazards and risks of serious injury. For example, safety considerations may require that the work zone 30 be clear of personnel. For example, the work zone 30 may need to be clear of remote operators, humans in general, animals in general, and/or other entities that may be undesirably injured or damaged and/or cause damage to work equipment, or increase a risk thereof, by their presence in the work zone 30 during operation of the machine 10. As referred to herein, the term human presence is meant to refer to such entities, unless expressly provided for otherwise, since mitigating human injury is typically an overriding safety consideration.

A controller 70 is communicatively coupled to the one or more image sensors 20A, 20B. The image sensors 20A, 20B may communicate in real time with a graphical user interface or GUI 60 (display, which may include or may be coupled to one or more processing units) and controller the 70. The controller 70 receives data from the image sensors 20A, 20B indicative of imaged scenes of the work zone 30. The controller 70 may cause the automatic shutdown of only the moving parts, e.g. a boom 11, of the machine 10 (stoppage of the machine 10) entirely based on data provided by the image sensors 20A, 20B.

The image sensors 20A, 20B generate data indicative of imaged scenes of the work zone 30. For example, a video may be represented as a temporal sequence of data structures formed from two-dimensional pixel array(s) of sensed (and processed) electromagnetic radiation (e.g. visible light, or infrared radiation) captured by the image sensors 20A, 20B. In various embodiments, a machine learning model may be used to process such data to detect personnel in the imaged scenes. For example, an object detection model may be used.

In some embodiments, the data from the image sensors 20A, 20B may be received by a processor integrated into cameras of the image sensors 20A, 20B and configured to use one or more machine learning models identify personnel in the work zone 30. In some cases, the controller 70 may further adjust subsequent safety protocol steps based on identity of a type of personnel or objects detected in the work zone 30. As referred to herein, a controller may include the processing elements of such integrated cameras. In some embodiments, one or more machine learning models may be used by a processor of a separate controller 70 to determine personnel. In various embodiments, the one or more machine learning models may include one or more object detection models that are suitable to recognize objects in the imaged scenes based on the data.

Transmission of data from the image sensors 20A, 20B to the controller 70, processing of the data at the controller 70, transmission of data to the GUI 60 (from the controller 70 and/or the image sensors 20A, 20B) and also to control shutdown operations all may occur in real time. Advantageously, this approach may thereby reduce lag or latency between personnel moving into the work zone 30 (unsafe area) and shutdown of the moving parts, e.g. a boom 11, or of the entire machine 10. Optionally, the safety protocols, including shutdown operations may also be communicated back to any in-cab operators within a cab of the equipment.

As illustrated in FIG. 2, the GUI 60 and the controller 70 are preferably located on or in the machine 10. In one embodiment the GUI 60 may include an integrated colour monitor display within a cab of the machine 10 enabling images from the image sensors 20A, 20B to be viewed by an in-cab operator, with an optional feature to provide recording capability to record images from the image sensors 20A, 20B. In other embodiments, GUI 60 does not incorporate any colour monitor and only a processor module may be present on the machine 10. In such cases, the processor may be located on the machine 10 in such a manner or location so as to provide physical protection to the processor. In various embodiments, the GUI 60 (and/or processor on-board the equipment) preferably connects to the controller 70 via a multi-conductor cable.

The image sensors 20A, 20B may be positioned and numbered with sufficient overlap of their respective fields of view 22A, 22B to ensure that even if the field of view of one of the image sensors is occluded another may still detect potential hazards covering a majority of the work zone 30 or at least a large portion of the work zone 30. Preferably, the detection area, or work zone 30, may be defined within each field of view 22A, 22B, which may be smaller than the union of fields of view 22A, 22B. In some embodiments, via the controller 70 and/or using the (machine learning) processing capabilities of camera(s) of the one or more image sensor 20A, 20B, it may be possible to choose classes of objects to detect, e.g. humans, animals, vehicles.

Since the work zone 30 is defined and monitored by the field of view 22 of the image sensors 20, it is not possible to bypass the work zone 30 as would occur in a threshold-based system once past the detection threshold in infrared detection curtains. For example, if the controller 70 or other part of the system 100 causes stoppage of the machine 10, it may not be possible to restart the machine 10 by simple moving personnel away from the boundary of the work zone 30 (further into the work zone 30) as the image sensors 20A, 20B monitor the whole work zone 30.

In tandem with the above first safety module, the present system 100 provides a second safety module in the form of a passive proactive early warning system. The second module may comprise a plurality of detectors 40A, 40B to monitor predetermined zones, referred to herein as operator zones 50A, 50B, where personnel can safely reside and from where remote operators can safely remotely operate the machine 10. The operator zones 50A, 50B are predetermined as they are defined by the respective regions in which the plurality of detectors 40A, 40B are able to perform detection, which regions are predetermined. As such, operator zones 50A, 50B are defined by the sensing range and position of the plurality of detectors 40A, 40B. The operator zones 50A, 50B defined by the plurality of detectors 40A, 40B are predetermined and non-overlapping. Furthermore, the plurality of operator zones 50A, 50B at least partially non-overlap the work zone 30. In some embodiments, the plurality of operator zones 50A, 50B do not overlap at all with the work zone 30. In various embodiments, operators may be permitted to operate the machine 10 only from with an operator zone 50A, 50B. For example, a remote control unit of the machine 10 used by an operator, and/or the machine 10 itself, may shutdown once an operator leaves all of the operator zones 50A, 50B.

The plurality of detectors 40A, 40B are suitable to detect personnel in the plurality of operator zones 50A, 50B without imaging the plurality of operator zones 50A, 50B, i.e. non-imaging detection is used by the plurality of detectors 40A, 40B to detect personnel. A non-imaging detector may be more robust than an imaging detector and may not be able to determine the type or quantity of personnel detected.

In some embodiments, the plurality of detectors 40A, 40B are motion sensors and/or passive infrared (PIR) detectors, e.g. differential PIR sensors. Passive infrared detectors require a human heat signature and movement to provide a “safe to operate” permissive trigger.

In FIG. 1, plurality of detectors 40A, 40B are shown as two detectors, defining corresponding two operator zones 50A, 50B. These operator zones 50A, 50B may initially be designated safe zones for personnel to enter. Any number of the plurality of detectors 40A, 40B such as the PIR detectors, may be positioned in the operational area of the machine 10 to define any number of operator zones 50A, 50B. Each detector of the plurality of detectors may define an exclusive one of the plurality of operator zones. The operator zone 50A, 50B may be defined anywhere, including within the cab of the machine 10. In practice, the operator zones 50A, 50B are limited in number, to define and somewhat restrict where personnel can freely move. In this way, more than simply detecting when personnel are in unsafe areas, the present second safety module may provide a proactive means of ensuring personnel are actually only present in confirmed operator zones 50A, 50B.

The controller 70 is communicatively coupled the plurality of detectors 40A, 40B. The plurality of detectors 40A, 40B may be in communication with the controller 70 to detect remote operator or personnel absence from the operator zones 50A, 50B and communicate the same to the controller 70. The controller 70 may determine next steps of the safety protocol, which may include automatic shutdown of only the moving parts, e.g. a boom 11, of the equipment or of the machine 10 entirely. Transmission of data from the plurality of detectors 40A, 40B to the GUI 60 and then transmission of personnel absence data to the controller 70 and subsequent shutdown operations may occur in real time with no lag or latency.

The plurality of detectors 40A, 40B may operate on 10VDC to 30VDC. The operator zones 50A, 50B preferably may have a diameter of between 0 to 8 meters. The output signal from the plurality of detectors 40A, 40B to controller 70 may be real-time and the plurality of detectors 40A, 40B preferably have a built-in second delay in relaying a signal of no detectable presence in the operator zones 50A, 50B, which prevents triggering a shutdown for a brief, temporary movement of a remote operator or personnel out of and back into the operator zones 50A, 50B, or in the case of a short period of time in which the operator is standing very still, although they are safely within the operator zones 50A, 50B. The operator zone 50A, 50B surface area may be modified by use of interchangeable eye guards (not shown) that may be applied to one or more of the plurality of detectors 40A, 40B having a smaller circumference of detection than the detector itself.

If a remote or personnel leaves an operator zone 50A, 50B for a predetermined period of time (e.g. more than 10 seconds) the plurality of detectors 40A, 40B may, via the controller 70, trigger an equipment shutdown. As such, the second safety module acts as a failsafe to the first safety module. As well, in the case where there is only one registered remote operator, if that remote operator is detected in one of the operator zones 50A, 50B, then the plurality of detectors 40A, 40B of the other of the operator zones 50B, 50A can trigger an equipment shutdown should personnel be detected in the other operator zone 50A, 50B, since in that particular scenario, no one else should be present.

The methods described herein may be automatically set based on the number and nature of the designated operator zones and the number of personnel planned to be working in the area.

In some embodiments, the first and second safety modules may both utilize cameras. However, such an arrangement may increase costs since imaging the work zone 30 and processing of imaged data may be significantly more costly than the use of non-imaged detection, e.g. differential sensing using passive infrared detectors. It is found that the first safety module PIR-based systems may not be sensitive/fast enough to detect changes in critical situations, such as the presence of personnel in an unsafe zone (e.g. the work zone 30). In some cases, a PIR system for use in the second, passive safety module may be preferable a proactive warning system, in relation to an enabling (GO) system. In various embodiments, higher fidelity machine learning models, image sensors, optical lenses and assemblies, and/or camera system may be preferred for a critical shutdown (NO GO) system.

The system 100 may include a safety indicator 14 to indicate unsafe operation or safe operation of the machine 10. Unsafe or safe operation of the machine 10 may refer to conditions where operation of the machine 10 may be respective unsafe or safe, e.g. respective unsafe or safe operating environments. For example, personnel present in the work zone 30 may lead to unsafe operation, i.e. unsafe operating conditions.

In some embodiments, the safety indicator 14 may include an audible alarm configured to generate sound to indicate unsafe operation of the machine 10. In some embodiments, the safety indicator 14 may include a lighting assembly configured to generate light to indicate unsafe operation of the machine 10. In various embodiments, the light assembly may include one or more lights for each of image sensors 20A, 20B and each of the detectors 40A, 40B to allow zone-specific indications (of safe or unsafe operation, for example). In some embodiments, the safety indicator 14 may be configured to generate a plurality of zone-specific indicators to indicate at least one of presence of personnel or no presence of personnel in the work zone and the plurality of operator zones 50A, 50B.

In some embodiments, the safety indicator 14 may be configured to generate a warning indicator when the controller 70 detects no personnel in the work zone and the controller 70 detects no personnel in the plurality of operator zones 50A, 50B.

In some embodiments, the safety indicator 14 may be operably coupled to the machine 10 and is configured to indicate unsafe operation of the machine 10 by causing stoppage of the machine 10 when the controller 70 detects no personnel in the work zone 30 and the controller 70 detects no personnel in the plurality of operator zones 50A, 50B.

In some embodiments, the safety indicator 14 may be operably coupled to the machine 10 and may be configured to indicate unsafe operation of the machine 10 by causing stoppage of the machine 10. For example, the safety indicator 14 may be or may include a shut-off switch 18, or may form part of the controller 70. The shut-off switch 18 may cause stop operation of a working end of the machine 10, e.g. a boom, while allowing the machine 10 to continue to run without moving.

In some embodiments, the safety indicator 14 may be controllably connected to a power source 16 of the machine 10 and may be configured to indicate unsafe operation of the machine 10 by controlling power supplied from the power source to the machine to prevent operation of the machine 10.

In various embodiments, it is understood that a monitored machine system may include machinery and the safety system 100, wherein the machinery includes the machine 10. For example, the one or more image sensors 20A, 20B may be mounted on the machine 10. For example, the plurality of detectors 40A, 40B may be mounted on the machine 10. Advantageously, as a result, the safety-monitored area moves with the machine 10, which may then reduce calibration or modification requirements and may also reduce the need for fixed site infrastructure.

In some embodiments, a loop circuit may be provided to monitor if the system 100 has been disabled or disconnected. For example, such a loop circuit may cause generation of a fault signal, e.g. via the safety indicator or by other means, to indicate that the safety system 100 has been disconnected. Advantageously, tampering with the safety system 100 may be prevented.

During operation, the controller 70 receives data from the one or more image sensors 20A, 20B indicative of imaged scenes of the work zone 30. The controller 70 uses a machine learning model to detect personnel in the imaged scenes (of the work zone 30) based on the data.

The controller 70 causes the safety indicator 14, e.g. an audible alarm, light, or shut-off switch, to indicate unsafe operation of the machine 10 in response to the machine learning model detecting personnel in the work zone 30.

The controller 70 causes the safety indicator 14 to indicate safe operation of the machine 10 in response to the plurality of detectors 40A, 40B detecting personnel in one of the plurality of operator zones 50A, 50B (a first operator zone) while detecting no personnel in any other of the plurality of operator zones 50A, 50B and while the machine learning model detects no personnel in the work zone 30.

The controller 70 causes the safety indicator 14 to indicate unsafe operation of the machine 10 in response to the plurality of detectors 40A, 40B detecting personnel in another operator zone of the plurality of operator zones 50A, 50B (a second operator zone) while detecting personnel in the first operator zone. The first and second operator zones are separate zones of the plurality of operator zones 50A, 50B.

The selection of the first and second operator zones from the plurality of operator zones 50A, 50B is not predetermined but is rather determined during operation based on detection of personnel. The spatial extent of each of plurality of operator zones 50A, 50B, including the first and second operator zones, is predetermined and may generally correspond to detection ranges of respective detectors of the plurality of detectors 40A, 40B.

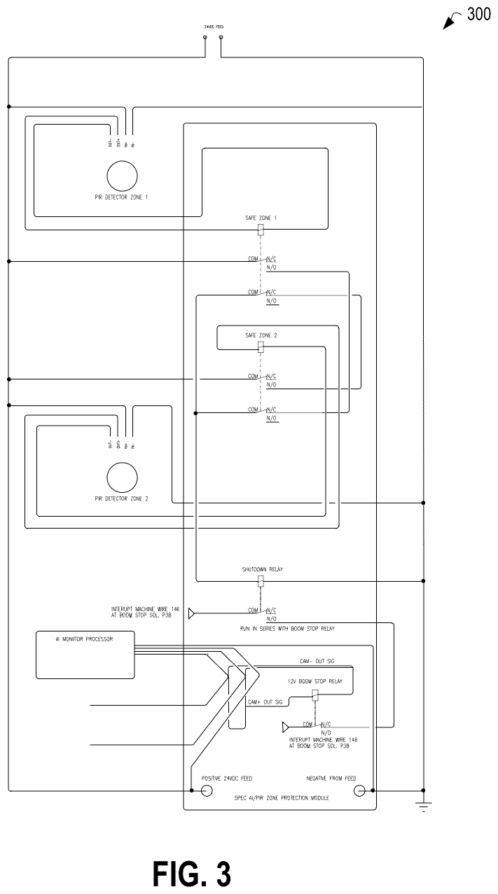

FIG. 3 is a circuit diagram 300 of the system, in accordance with an embodiment. The circuit diagram 300 illustrates one example of a circuit layout for powering and controlling elements of the system 100 described herein.

A further preferred embodiment of the first safety module may include any means of detecting occlusion of a lens positioned to form a field of view for one or more of the image sensors 20A, 20B or failure of any other part of an image sensor or a camera using it. Similarly, the processor may be preferably programmed to detect and communicate any failures in the plurality of detectors 40A, 40B.

In an embodiment, a video uplink of footage from the image sensors 20A, 20B may be uploaded and recorded for any instances of entry into the work zone 30. This may allow onsite teams to review circumstances around such a safety breach in order to avoid it in future. Similarly, preferably the present system 100 may allow for recording of events that trigger the safety protocol, to provide to onsite teams for monitoring safety culture.

The system 100 may be configured with a varying number and locations of image sensors 20A, 20B and plurality of detectors 40A, 40B depending on the variety of machine 10 and industry of use, in order to better define operator zones 50A, 50B and the work zone 30 within the operating environment. The first safety module, second safety module and the GUI 60 and controller 70 of the system 100 can further be configured with specifications and pre-set information about particular pieces of machine 10 and their moving parts, e.g. a boom 11, to provide tailored safety monitoring each equipment to be used.

Both first and second safety modules may detect personnel without reliance on external hardware such as RFID tags. As well, since the first and second safety modules scan entire zones (work zone 30 and operator zones 50A, 50B), not just a threshold, they cannot be bypassed. Furthermore, the present system 100 may be used to detect other humans, animals, or vehicles other than remote operators, who may be present and who may be injured or damaged if they enter the work zone 30 of the machine 10. The present system 100 and method may significantly reduce the chance of safety failures due to human error, or unexpected conditions such as an unexpected person in the equipment's proximity.

The system 100 may be adaptable to a wide variety of machinery or machines 10, e.g. heavy equipment, and variety of safety variables. Consequently, the system 100 may be adopted across multiple sectors that use heavy equipment and need improved safety systems.

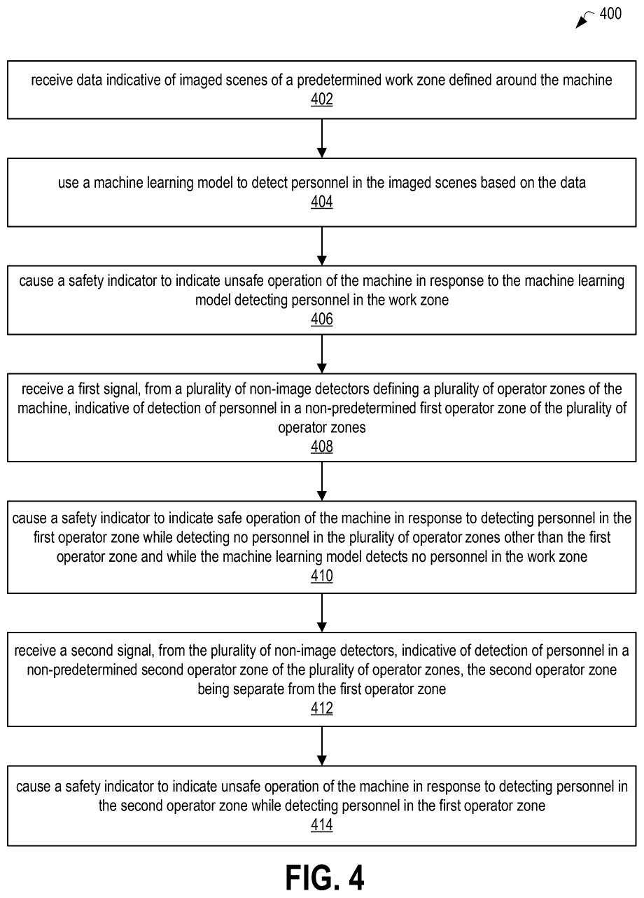

FIG. 4 is a flow chart of an example method 400 of safely operating a machine.

Step 402 of the method includes receiving data indicative of imaged scenes of a predetermined work zone defined around the machine.

Step 404 of the method includes using a machine learning model to detect personnel in the imaged scenes based on the data.

Step 406 of the method includes causing a safety indicator to indicate unsafe operation of the machine in response to the machine learning model detecting personnel in the work zone.

Step 408 of the method includes receiving a first signal, from a plurality of non-image detectors defining a plurality of operator zones of the machine, indicative of detection of personnel in a non-predetermined first operator zone of the plurality of operator zones.

The selection of the first operator zone from the plurality of operator zones is not predetermined but is rather determined during operation based on detection of personnel. For greater clarity, the spatial extent of each of the operator zones, including the first operator zone, is predetermined and may generally correspond to detection ranges of respective detectors of the plurality of detectors.

Step 410 of the method includes causing a safety indicator to indicate safe operation of the machine in response to detecting personnel in the first operator zone while detecting no personnel in the plurality of operator zones other than the first operator zone and while the machine learning model detects no personnel in the work zone.

Step 412 of the method includes receiving a second signal, from the plurality of non-image detectors, indicative of detection of personnel in a non-predetermined second operator zone of the plurality of operator zones, the second operator zone being separate from the first operator zone.

The selection of the second operator zone from the plurality of operator zones is not predetermined but is rather determined during operation based on detection of personnel. As mentioned previously, the spatial extent of each of the operator zones, including the second operator zone, is predetermined and may generally correspond to detection ranges of respective detectors of the plurality of detectors.

Step 414 of the method includes causing a safety indicator to indicate unsafe operation of the machine in response to detecting personnel in the second operator zone while detecting personnel in the first operator zone.

In some embodiments of the method 400, the safety indicator, to indicate unsafe operation, causes stoppage of the machine by preventing supply of power to the machine, and the safety indicator, to indicate safe operation, causes supply of power to the machine.

In some embodiments of the method 400, the plurality of detectors includes a plurality of passive infrared sensors.

In some embodiments of the method 400, causing a safety indicator to indicate unsafe operation of the machine includes causing operation of an audible alarm.

In some embodiments of the method 400, the data is generated by an optical image sensor.

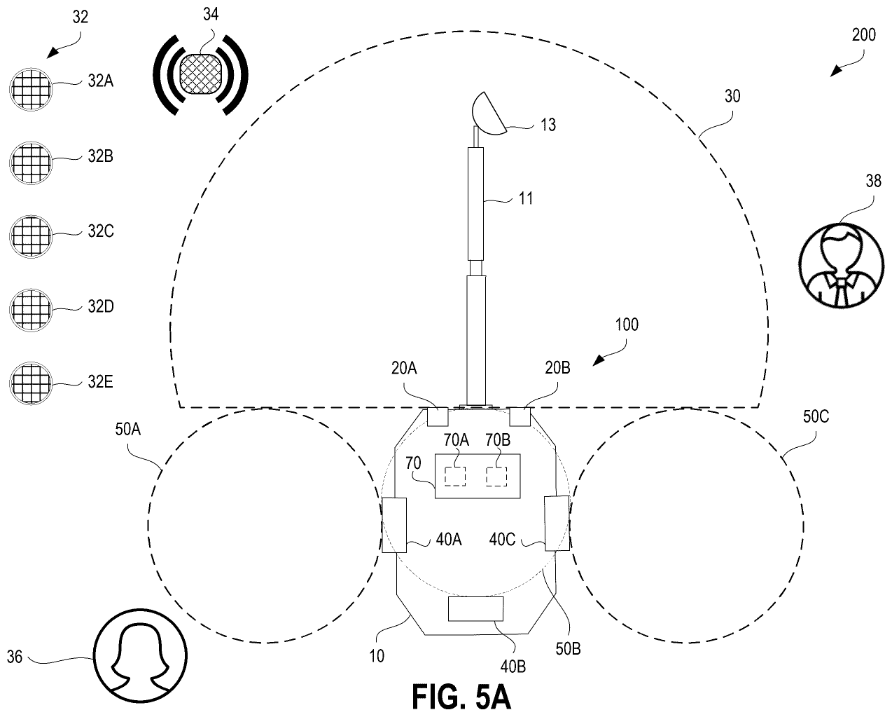

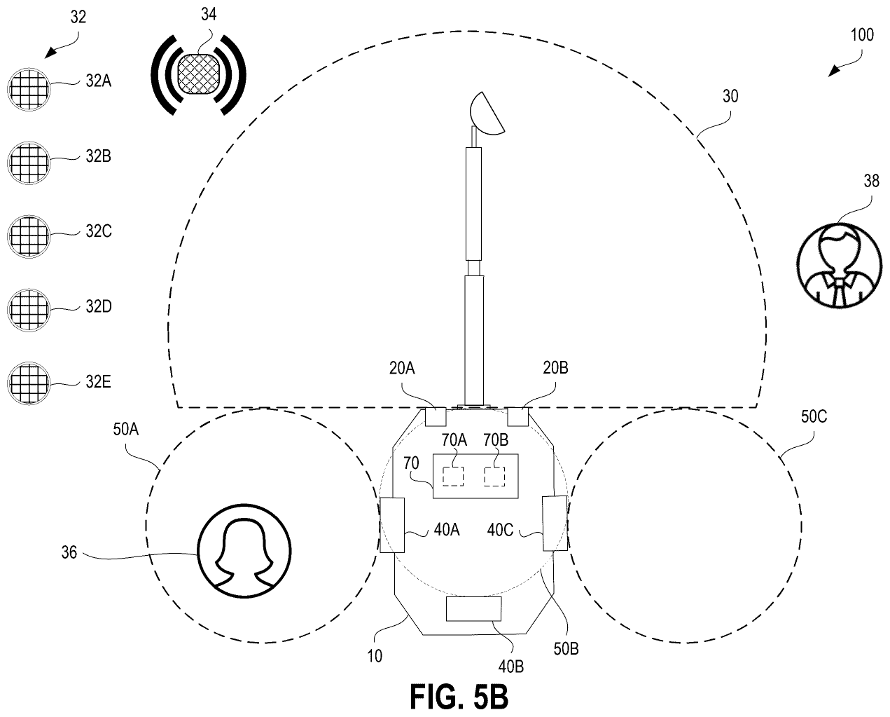

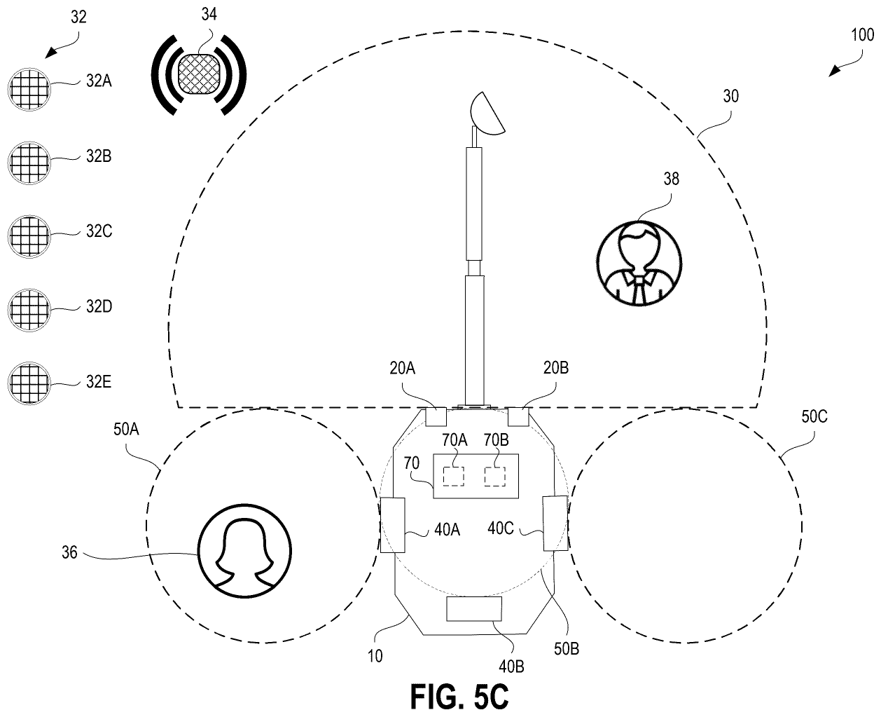

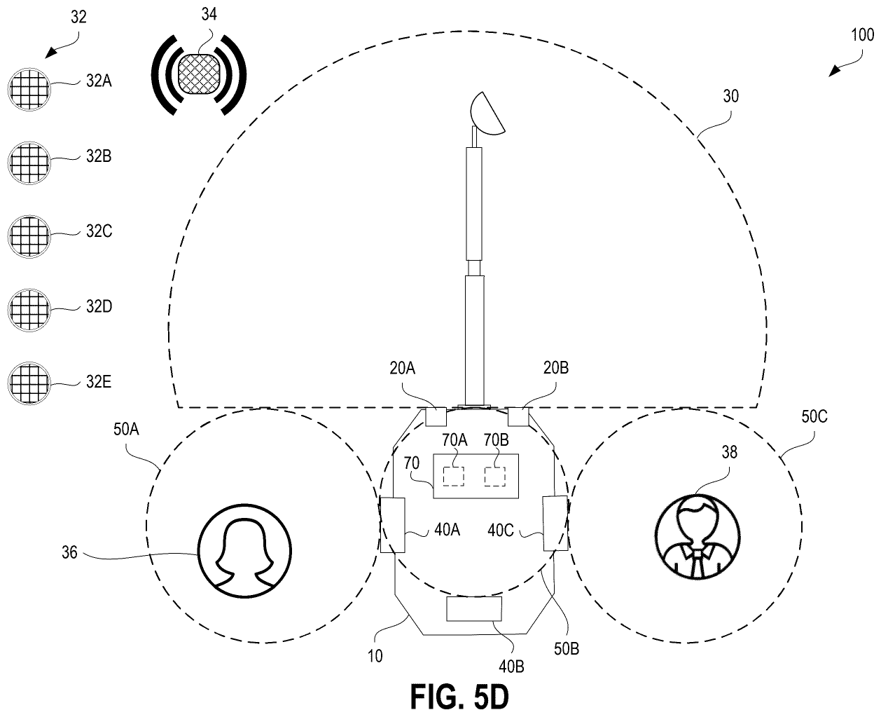

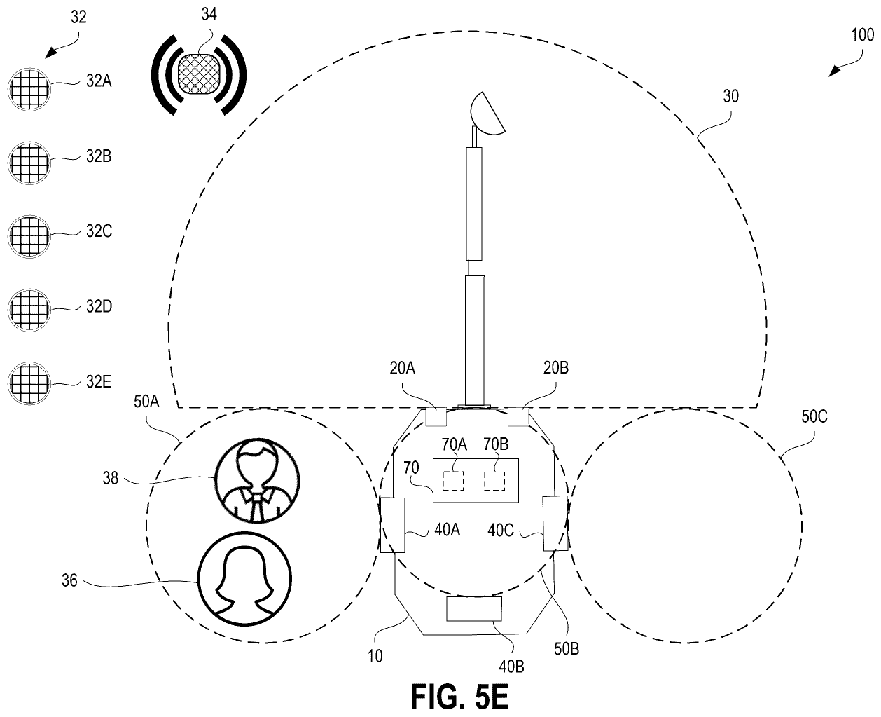

FIGS. 5A-5E illustrate various stages of operation of a monitored machine system 200, in accordance with an embodiment.

Referring to FIGS. 5A-5E, the monitored machine system 200 includes a machine 10 and safety system 100. For example, the machine 10 may include a boom 11 equipped with a tool head 13. A range of movement of the boom 11 may define a hazardous area for personnel.

The safety system 100 of the monitored machine system 200 includes camera(s) defining two image sensors 20A, 20B and three detectors 40A, 40B, 40C communicatively connected to a controller 70.

A work zone 30 defined by the image sensors 20A, 20B is shown schematically solely for illustrative purposes in FIGS. 5A-5E. Operator zones 50A, 50B, 50C defined by respective detectors 40A, 40B, 40C are shown schematically solely for illustrative purposes in FIGS. 5A-5E.

The system 100 includes a plurality of lights 32 or a lighting assembly, including lights 32A-32E, and an audible alarm 34, operatively connected to the controller 70. The lights 32A-32E may be zone-specific lights, e.g. the lights 32A, 32B, 32C, 32D, 32E may be associated with and responsive to the respective detectors 40A, 40B, 40C and image sensors 20A, 20B. As referred to herein, lights may include lighting assemblies.

For the purposes of clarity, connections between the sensors 20A, 20B, the detectors 40A, 40B, 40C, the plurality of lights 32, and the audible alarm 34, and the controller 70 are not shown in FIGS. 5A-5E.

The various stages of operation of the monitored machine system 200 are illustrated in FIGS. 5A-5E with respect to a first person 36 and a second person 38 (example personnel). For example, the first person 36 may be an operator and the second person 38 may be a pedestrian.

As shown in FIG. 5A, in a first stage of operation of the monitored machine system 200, the first person 36 and the second person 38 are both positioned outside the work zone 30 and the operator zones 50A, 50B, 50C. In the first stage operation, the lights 32A-32E may be turned off or turned on with a similar colour, e.g. amber, to indicate an unsafe operation or a specific standby condition of the machine 10. In some embodiments, the audible alarm 34 may make no sound and/or may emit a low intensity sound, e.g. a 90 dB sound, in the first stage of operation to indicate unsafe operation or a specifically that no operator is present in the vicinity of the machine 10. In some embodiments, the controller 70 may prevent operation (causes stoppage) of the machine 10, e.g. movement of the boom 11, in the first stage of operation. Stoppage may be achieved by electrical cut-off, mechanical obstruction, or other means. Advantageously, this may prevent inadvertent operation of the machine 10 when an operator is not present in proximity to the machine 10.

As shown in FIG. 5B, in a second stage of operation of the monitored machine system 200, the first person 36 is positioned in a first operator zone 50A and thereby detected by the detector 40A, and the second person 38 is positioned outside the work zone 30 and the operator zones 50A, 50B, 50C. In the second stage operation, in some embodiments, the lights 32A-32E may be turned off or turned on with a similar colour, e.g. green, to indicate a safe operation or specifically an active or a fully operational condition of the machine 10. In some embodiments, the audible alarm 34 may make no sound to indicate safe operation or specifically that no operator is present in the vicinity of the machine 10. In the second stage of operation, the plurality of lights 32 and the audible alarm 34 may operate to avoid and reduce operator discomfort relative to their operation during other stage of operation of the monitored machine system 200, so as to encourage personnel to position themselves to achieve safety or safe operation. In the second stage of operation, the controller 70 may energize the machine 10, either by directly operating a switch to energize the machine 10 or by avoiding operating a switch that would cause stoppage, e.g. by cutoff of power, of the machine 10. In some embodiments, the boom 11 or the machine 10 may be operable only during such a safe stage of operation of the monitored machine system 200. In various embodiments, a loop circuit may be provided to mitigate user tampering to allow operation of the boom 11 or the machine 10 not in such a safe stage of operation.

In the second stage of operation, the operator zones 50B, 50C, i.e. operator zones other than the first operator zone 50A, are designated unsafe zones, as illustrated in reference to FIG. 5D. In a preferred embodiment, in the second stage of operation, the light 32A associated with the detector 40A may be operated to appear visibly different than the remaining lights 32B-32E to indicate that an operator is present in the operator zone 50A and not in zones 50B or 50C. Furthermore, the lights 32B-32E may appear be operated to appear visually similar to indicate to a user that zones 50B, 50C and the work zone 30 are unsafe zones.

As shown in FIG. 5C, in a third stage of operation of the monitored machine system 200, the first person 36 is positioned in a first operator zone 50A and thereby detected by the detector 40A, and the second person 38 is positioned in the work zone 30.

In the third stage of operation, the light 32E associated with the image sensor 20B may be operated to appear visibly different than the lights 32B-32D to indicate that personnel, other than an operator, is present in the work zone 30, and specifically in the field of view of image sensor 20B, and not elsewhere. In some embodiments, the light 32A associated with the detector 40A may be operated to appear visibly different than the remaining lights 32B-32E to indicate than an operator since an operator may operate the machine 10 only from an operator zone.

As shown in FIG. 5D, in a fourth stage of operation of the monitored machine system 200, the first person 36 is positioned in a first operator zone 50A and thereby detected by the detector 40A, and the second person 38 is positioned in a second operator zone 50C and thereby detected by the detector 40C.

In the fourth stage of operation, the light 32C associated with the detector 40C may be operated to appear visibly different than the lights 32B, 32D, 32E to indicate that personnel are present in two operator zones 50A, 50C simultaneously.

In some embodiments, the light 32A and the light 32C may be operated to appear visibly similar as the controller 70 may not be capable of distinguishing between operator and non-operator personnel, e.g. a light appearance associated with an operator may appear on a light only when the remaining lights show no presence of personnel therein. In some embodiments, the light 32A associated with the detector 40A may be operated to appear visibly different than the light 32C to indicate than an operator is present in operator zone 50A and not elsewhere. For example, the controller 70 may distinguish between an operator and non-operator based on chronological order of appearance in the operator zones 50A-50C. Advantageously, greater robustness, flexibility, reliability, and privacy may be achieved by avoiding personnel-specific identification. Advantageously, spatial movements of personnel may be tracked based on their movements between zones, since the plurality of lights 32 are operated in a zone-specific manner.

In some embodiments, all the lights 32-32E are simultaneously operated to indicate a general hazard and unsafe operation of the machine 10.

In both the third and fourth stages of operation, the audible alarm 34 may emit a higher intensity sound associated with hazard (hazard detection) or danger. For example, such a sound may be a broadband frequency sound.

In some embodiments, the controller 70 may prevent operation (causes stoppage) of the machine 10, e.g. movement of the boom 11, in the third and fourth stages of operation. Advantageously, this may unsafe operation of the machine 10, i.e. operation of the machine when personnel are present in unsafe zones around, about, or in proximity to the machine 10.

As shown in FIG. 5E, in a fifth stage of operation of the monitored machine system 200, the first person 36 and second person 38 are both positioned in the first operator zone 50A and thereby detected by the detector 40A. Since the detector 40A may generally be incapable of identifying the type and quantity of detected personnel, the safety system 100 may operate identically in the first and fifth stages of operation.

It is understood that additional lights may be provided. For example, one or more lights may be provided to indicate a system-wide status. For example, a red light may indicate stoppage of the machine 10 and the presence of a hazard in an unsafe area, a yellow light may indicate an inactive condition of the machine 10 in response to an absence of an operator, and a green light may indicate an active, safe condition of the machine in response to presence of an operator in an operator zone while no personnel are present in the remaining operator zones 50A, 50B, 50C and the work zone 30.

In various embodiments, the controller 70 may include two or more sub-components. For example, as shown in FIGS. 5A-5E, the controller 70 may include first circuitry 70A and second circuitry 70B. The first circuitry 70A may be operatively and/or communicatively coupled to the plurality of detectors 40A, 40B, 40C and the second circuitry 70B may be operatively and/or communicatively coupled to the image sensors 20A, 20B. In various embodiments, the first circuitry 70A may remain not be directly connected to the second circuitry 70B. In various embodiments, the first circuitry 70A may be substantially analog circuitry and the second circuitry 70B may include one or more processors, non-transitory computer-readable media, and so on. Advantageously, greater system robustness and redundancy may be achieved.

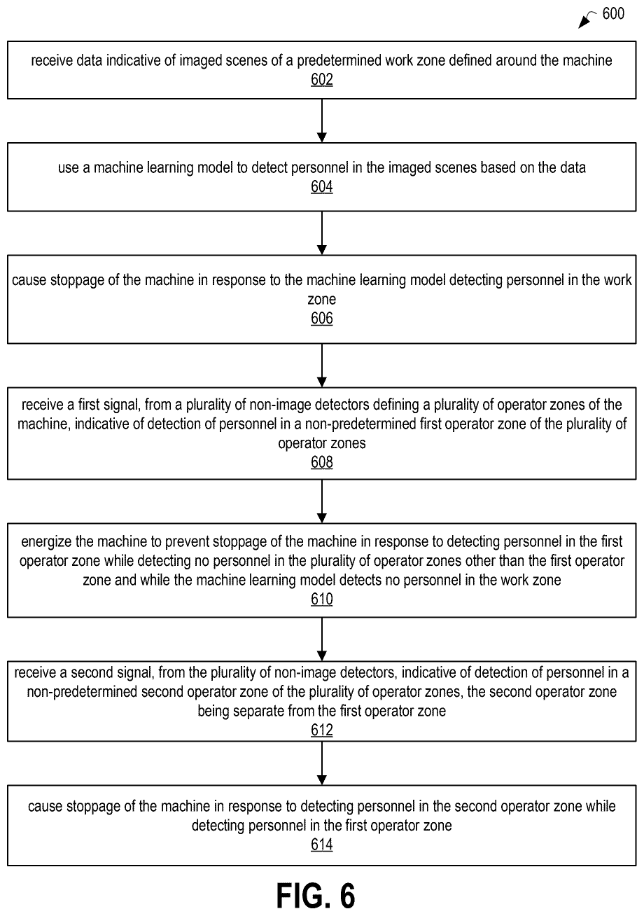

FIG. 6 is a flow chart of another example method 600 of safely operating a machine.

Step 602 of the method 600 includes receiving data indicative of imaged scenes of a predetermined work zone defined around the machine.

Step 604 of the method 600 includes using a machine learning model to detect personnel in the imaged scenes based on the data.

Step 606 of the method 600 includes causing stoppage of the machine in response to the machine learning model detecting personnel in the work zone.

Step 608 of the method 600 includes receiving a first signal, from a plurality of non-image detectors defining a plurality of operator zones of the machine, indicative of detection of personnel in a non-predetermined first operator zone of the plurality of operator zones.

Step 610 of the method 600 includes energizing the machine to prevent stoppage of the machine in response to detecting personnel in the first operator zone while detecting no personnel in the plurality of operator zones other than the first operator zone and while the machine learning model detects no personnel in the work zone.

Step 612 of the method 600 includes receiving a second signal, from the plurality of non-image detectors, indicative of detection of personnel in a non-predetermined second operator zone of the plurality of operator zones, the second operator zone being separate from the first operator zone.

Step 614 of the method 600 includes causing stoppage of the machine in response to detecting personnel in the second operator zone while detecting personnel in the first operator zone.

The selection of the first and second operator zones from the plurality of operator zones is not predetermined but is rather determined during operation based on detection of personnel. The spatial extent of each of the operator zones, including the first and second operator zones, is predetermined and may generally correspond to detection ranges of respective detectors of the plurality of detectors.

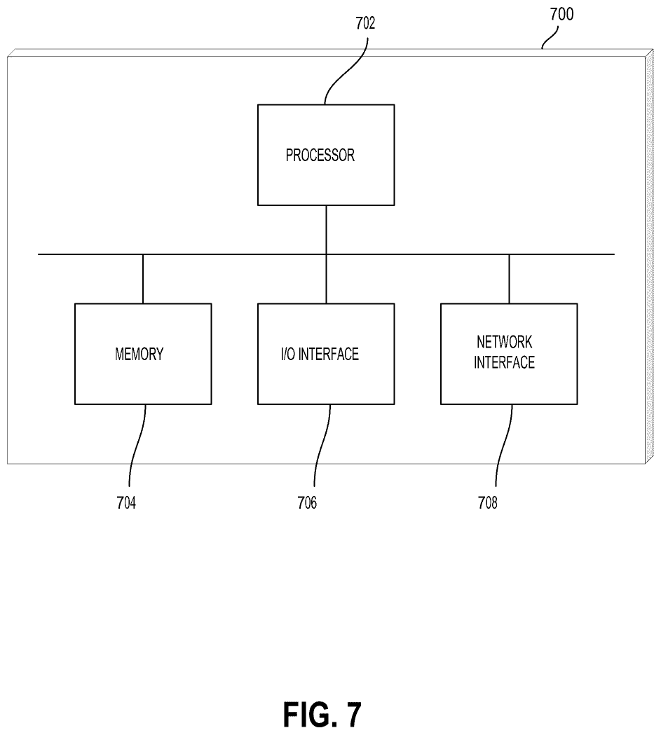

FIG. 7 illustrates a block diagram of a computing device 700, in accordance with an embodiment of the present application.

As an example, the system 100, the monitored machine system 200, the controller 70, the second circuitry 70B, a remote control unit, the method 400, the method 600, the circuitry of FIG. 2 and/or FIG. 3, the safety indicator 14, the GUI 60, control of power source 16, or the shut-off switch 18 may be implemented using the example computing device 700 of FIG. 7.

The computing device 700 includes at least one processor 702, memory 704, at least one I/O interface 706, and at least one network communication interface 708.

The processor 702 may be a microprocessor or microcontroller, a digital signal processing (DSP) processor, an integrated circuit, a field programmable gate array (FPGA), a reconfigurable processor, a programmable read-only memory (PROM), or combinations thereof.

The memory 704 may include a computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM).

The I/O interface 706 may enable the computing device 700 to interconnect with one or more input devices, such as a keyboard, mouse, camera, touch screen and a microphone, or with one or more output devices such as a display screen and a speaker.

The networking interface 708 may be configured to receive and transmit data sets representative of the machine learning models, for example, to a target data storage or data structures. The target data storage or data structure may, in some embodiments, reside on a computing device or system such as a mobile device.

There may be provided a non-transitory computer-readable medium having stored thereon machine interpretable instructions which, when executed by a processor, cause the processor to execute one or more methods described above.

There may be provided a system comprising: a processor; computer-readable memory coupled to the processor and storing processor-executable instructions that, when executed, configure the processor to execute one or more methods described above.

As can be understood, the examples described above and illustrated are intended to be exemplary only. The embodiments described in this document provide non-limiting examples of possible implementations of the present technology. Upon review of the present description, a person of ordinary skill in the art will recognize that changes may be made to the embodiments described herein without departing from the scope of the present technology. For example, a processor may include multiple processors and/or multi-threaded processors, indication of safe operation may be achieved by not providing any specific indication, detectors may include ultrasonic detectors, and image sensors may include image sensors generating images based on visible light, thermal infrared, microwave radiation, time-of-flight, or other principles of operation. Yet further modifications could be implemented by a person of ordinary skill in the art in view of the present disclosure, which modifications would be within the scope of the present technology.

The term “connected” or “coupled to” may include both direct coupling (in which two elements that are coupled to each other contact each other) and indirect coupling (in which at least one additional element is located between the two elements).

What is claimed is:

1. A safety system for a machine, comprising:
one or more image sensors positioned to image a predetermined work zone around the machine;
a plurality of detectors defining a predetermined plurality of operator zones of the machine that are non-overlapping, the plurality of detectors being suitable to detect personnel in the plurality of operator zones without imaging the plurality of operator zones, the plurality of operator zones at least partially non-overlapping the work zone; and
a controller communicatively coupled to the one or more image sensors and the plurality of detectors, the controller configured to
receive data from the one or more image sensors indicative of imaged scenes of the work zone,
use a machine learning model to detect personnel in the imaged scenes based on the data,
cause a safety indicator to indicate unsafe operation of the machine in response to the machine learning model detecting personnel in the work zone,
cause the safety indicator to indicate safe operation of the machine in response to the plurality of detectors detecting personnel in a non-predetermined first operator zone of the plurality of operator zones while detecting no personnel in the plurality of operator zones other than the first operator zone and while the machine learning model detects no personnel in the work zone, and
cause the safety indicator to indicate unsafe operation of the machine in response to the plurality of detectors detecting personnel in a non-predetermined second operator zone of the plurality of operator zones while detecting personnel in the first operator zone, the second operator zone being separate from the first operator zone.

2. The safety system of claim 1, wherein the safety indicator includes an audible alarm configured to generate sound to indicate unsafe operation of the machine.

3. The safety system of claim 1, wherein the safety indicator includes a lighting assembly configured to generate light to indicate unsafe operation of the machine.

4. The safety system of claim 1, wherein the safety indicator is configured to generate a plurality of zone-specific indicators to indicate at least one of presence of personnel or no presence of personnel in the work zone and the plurality of operator zones.

5. The safety system of claim 1, wherein the safety indicator is operably coupled to the machine and is configured to indicate unsafe operation of the machine by causing stoppage of the machine when the controller detects no personnel in the work zone and the controller detects no personnel in the plurality of operator zones.

6. The safety system of claim 1, wherein the plurality of detectors includes a plurality of motion sensors.

7. The safety system of claim 1, wherein the machine learning model is an object detection model suitable to recognize objects in the imaged scenes based on the data.

8. The safety system of claim 1, wherein each detector of the plurality of detectors defines an exclusive one of the plurality of operator zones.

9. The safety system of claim 1, wherein the safety indicator is operably coupled to the machine and is configured to indicate unsafe operation of the machine by causing stoppage of the machine.

10. The safety system of claim 1, wherein the safety indicator is controllably connected to a power source of the machine and is configured to indicate unsafe operation of the machine by controlling power supplied from the power source to the machine to prevent operation of the machine.

11. The safety system of claim 1, wherein the plurality of detectors includes a plurality of passive infrared sensors.

12. The safety system of claim 1, wherein the one or more image sensors are optical image sensors.

13. A monitored machine system, comprising:
machinery; and
a safety system according to claim 1, wherein the machinery includes the machine.

14. The monitored machine system of claim 13, wherein the one or more image sensors are mounted on the machinery.

15. The monitored machine system of claim 14, wherein the plurality of detectors is mounted on the machinery.

16. A method of safely operating a machine, comprising:
receiving data indicative of imaged scenes of a predetermined work zone defined around the machine;
using a machine learning model to detect personnel in the imaged scenes based on the data;
causing a safety indicator to indicate unsafe operation of the machine in response to the machine learning model detecting personnel in the work zone;
receiving a first signal, from a plurality of non-image detectors defining a plurality of operator zones of the machine, indicative of detection of personnel in a non-predetermined first operator zone of the plurality of operator zones;
causing the safety indicator to indicate safe operation of the machine in response to detecting personnel in the first operator zone while detecting no personnel in the plurality of operator zones other than the first operator zone and while the machine learning model detects no personnel in the work zone;
receiving a second signal, from the plurality of non-image detectors, indicative of detection of personnel in a non-predetermined second operator zone of the plurality of operator zones, the second operator zone being separate from the first operator zone; and
causing the safety indicator to indicate unsafe operation of the machine in response to detecting personnel in the second operator zone while detecting personnel in the first operator zone.

17. The method of claim 16, wherein the safety indicator, to indicate unsafe operation, causes stoppage of the machine by preventing supply of power to the machine, and the safety indicator, to indicate safe operation, causes supply of power to the machine.

18. The method of claim 16, wherein the plurality of detectors includes a plurality of passive infrared sensors.

19. The method of claim 16, further comprising:
receiving a third signal, from the plurality of non-image detectors, indicative of detection of no personnel in the plurality of operator zones; and
causing stoppage of the machine in response to the third signal.

20. A method of safely operating a machine, comprising:
receiving data indicative of imaged scenes of a predetermined work zone defined around the machine;
using a machine learning model to detect personnel in the imaged scenes based on the data;
causing stoppage of the machine in response to the machine learning model detecting personnel in the work zone;
receiving a first signal, from a plurality of non-image detectors defining a plurality of operator zones of the machine, indicative of detection of personnel in a non-predetermined first operator zone of the plurality of operator zones;
energizing the machine to prevent stoppage of the machine in response to detecting personnel in the first operator zone while detecting no personnel in the plurality of operator zones other than the first operator zone and while the machine learning model detects no personnel in the work zone;
receiving a second signal, from the plurality of non-image detectors, indicative of detection of personnel in a non-predetermined second operator zone of the plurality of operator zones, the second operator zone being separate from the first operator zone; and
causing stoppage of the machine in response to detecting personnel in the second operator zone while detecting personnel in the first operator zone.
